(19) United States
(12) Patent Application Publication
(10) Pub. No.: US 2017/0180136 A1
(43) Pub. Date: Jun. 22, 2017

(54) AUTHENTICATION SYSTEM AND METHOD

(71) Applicant: EINNOVATIONS HOLDINGS PTE. LTD., SINGAPORE (SG)

(72) Inventor: Alex D. IBASCO, Pasig City (PH)

(73) Assignee: EINNOVATIONS HOLDINGS PTE. LTD., SINGAPORE (SG)

(21) Appl. No.: 15/116,200

(22) PCT Filed: Feb. 11, 2015
(86) PCT No.: PCT/SG2015/050019

§ 371 Date: Aug. 2, 2016

(30) Foreign Application Priority Data
Feb. 11, 2014 (SG) 2014011308

(51) Int. Cl. H04L 9/32; G06Q 20/40; H04L 12/26; H04L 29/06; H04L 9/06

(52) U.S. Cl. CPC H04L 9/3247; H04L 63/0853; H04L 63/083; H04L 63/0428; H04L 9/0631; H04L 9/3242; H04L 9/3234; H04L 43/106; G06Q 20/4012; H04L 2463/121; H04L 2209/56; G06Q 2220/00

(57) ABSTRACT

An authentication system comprising an authentication device comprising a subscriber identity module (SIM), the SIM operable to encrypt data in relation to a transaction for sending over a communication network; the encrypted data comprises transaction details, time stamp and signature; an authentication host operable to receive encrypted data sent over the communication network, the authentication host operable to decrypt the data sent and process the transaction accordingly, is disclosed.

### FIELD OF THE INVENTION

The present invention relates to an authentication system and method. The system and method are particularly relevant, but not limited to a SIM-based account authentication and will be described in such context.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Passwords or personal identification numbers (PINs) have been used for the authentication of transactions over various communication protocols, in particular financial transactions such as online banking. In recent years, for added security there are two-factor authentication mechanisms and associated procedures.

In general, the uses of PINs or passwords on an entry portal (web-based, POS-terminal-based) is single-factor authentication mechanism and are deemed to be inferior mechanisms compared to two-factor authentication.

Two-factor authentication, however, requires that a user have both “what you know” (PIN or Password) and “what you have” (card or device). Without the second factor, entry portal PIN/password authentication falls prey to human eavesdropping, and to virus key loggers and spyware.

In the case of authentication via generation of a one-time-password sent via a communication protocol such as SMS, this is indeed two-factor authentication with “what you know” (User ID) and “what you have” (mobile device). However, it is error-prone with the user having to type in the one-time password exactly as texted within a predetermined time, otherwise a new password has to be generated.

In addition to the commonly employed SMS based authentication, push-based PIN prompting via USSD (Unstructured Supplementary Service Data) is also a form of two-factor authentication with “what you know” (User ID, password) and “what you have” (mobile device). The use of Unstructured Supplementary Service Data (USSD), a protocol used by GSM cellular telephones to communicate with the service provider's computers, may be used as another way to authenticate. USSD provides another way is used by telecommunications system to provide quick interactive menus to subscribers; e.g., for roaming calls. It can be used to prompt for a PIN or password. However, USSD authentication lacks strong security, relying only on basic GSM encryption, which is now considered insufficient (algorithm A5/1 has been hacked since 2009 to allow eavesdropping in real-time).

There exists a need to improve push-based PIN prompting via USSD to improve the security of the same.

The invention seeks to improve on USSD-based PIN prompting by providing strong security over a plurality of communications channels including (but not limited to) SMS, GSM GPRS, 3G Data, and 802.11b/g/n Wi-Fi.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

In accordance with a first aspect of the invention there is an authentication system comprising an authentication device, the authentication device comprising a subscriber identity module (SIM), the SIM operable to encrypt data in relation to a transaction for sending over a communication network; the encrypted data comprises information relating to the transaction, a personal identification number (PIN), and a digital signature; and an authentication host operable to receive encrypted data sent over the communication network, the authentication host operable to decrypt the data sent and process the transaction.

Preferably, the authentication host comprises a hardware security module (HSM) operable to decrypt the encrypted data.

Preferably, the HSM is operable to validate the digital signature.

Preferably, the HSM is operable to validate the PIN.

Preferably, the authentication host is operable to receive a transaction request from a merchant.

Preferably, upon receipt of the transaction request, the authentication host is operable to encrypt the transaction request and sends a prompt for identification to the authentication device.

Preferably, the authentication host comprises an account database for verifying the transaction request.

In accordance with a second aspect of the present invention there is provided an authentication device comprising a subscriber identity module (SIM), the SIM operable to encrypt and decrypt data in relation to a transaction for sending over a communication network, the SIM comprising at least two of the following authentication protocol:—Standard GSM or 3G Authentication Keys; GSM 03.48 Bearer Encryption Key; STK-based PIN Prompt; STK-based Transaction Data Prompt; ANSI X9.24 DUKPT 128-bit PIN Encryption Key; ANSI X9.24 DUKPT Plug-in; AES-128 Transaction Data Encryption Key; AES-128 Plug-in; AES-128 CBC-MAC Signature Key; and AES-128 CBC-MAC Plug-in.

Preferably, upon receipt of a request for authentication that includes a personal identification number from a user, the authentication device formats the personal identification number into a standard ISO format and encrypts the PIN using a DUKPT encryption key.

Preferably, the SIM is further operable to generate a transaction number to the PIN, and append the transaction number and PIN.

Preferably, the SIM is operable to timestamp the response to the request for authentication and generate a SIM signature key.

In accordance with a third aspect of the invention there comprises an authentication host operable to receive a transaction request, and encrypt the transaction request to generate a prompt for identification; the authentication host comprises a hardware security module (HSM) for encrypting the prompt for identification; wherein the prompt for identification comprises a data packet comprising a transaction number, time stamp, and a digital signature.

In accordance with a fourth aspect of the invention there comprises an authentication method, the method comprising the steps of:—receiving a transaction request from a source; generating and encrypting a request for identification to be sent to an authentication device; at the authentication device, decrypting the request for identification; prompting the source to enter the identification;

wherein upon receiving the identification, encrypting the identification.

Preferably, the

In accordance with a fifth aspect of the present invention there is provided a Subscriber Identification module (SIM) for use in a mobile device to perform the function of an authentication device in accordance with the first or second aspect.

### BRIEF DESCRIPTION OF THE DRAWINGS

The present invention will now be described, by way of example only, with reference to the accompanying drawings, in which:

FIG. 1 shows an authentication system in accordance with an embodiment of the invention;

FIG. 2 shows an example of a PIN prompt to a user for authentication to proceed with an online purchase in accordance with an embodiment of the invention; and

FIGS. 3a to 3c shows examples of a PIN prompt to a user for authentication to proceed with different types of applications in accordance with other embodiments of the invention.

Other arrangements of the invention are possible and, consequently, the accompanying drawings are not to be understood as superseding the generality of the description of the invention.

### DESCRIPTION OF EMBODIMENTS OF THE INVENTION

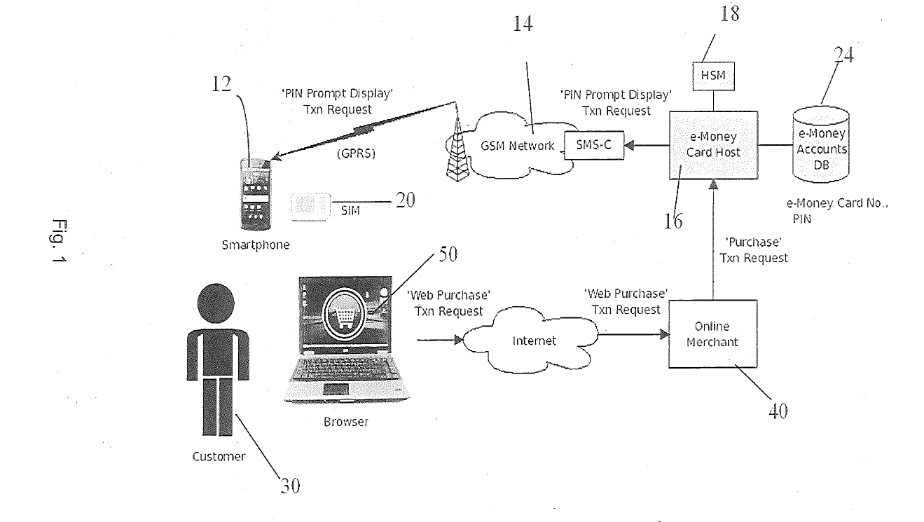

In accordance with an embodiment of the invention and with reference to FIG. 1 there is an authentication system 10 comprising a user device 12 in data communication with an authentication host 16 for authenticating transaction requests with, for example, online merchants 40.

The user device 12 functions as an authentication device 12 comprising a subscriber identity module (SIM), the SIM operable to encrypt/decrypt data in relation to a transaction for sending over a communication network; the encrypted/decrypted data comprises information relating to the transaction and a digital signature. In one embodiment, such data in relation to a transaction may be in the form of a request or prompt for identification.

The authentication device 12 is a mobile phone 12 having a SIM card 20. SIM card 20 comprises means for authentication and is hereinafter used interchangeably with the term ‘Crypto SIM’ 20. The Crypto SIM 20 comprises two or more of the following features:
a. Standard GSM or 3G Authentication Keys;
b. GSM 03.48 Bearer Encryption Key;
c. STK-based PIN Prompt;
d. STK-based Transaction Data Prompt;
e. ANSI X9.24 DUKPT 128-bit PIN Encryption Key;
f. ANSI X9.24 DUKPT Plug-in;
g. AES-128 Transaction Data Encryption Key;
h. AES-128 Plug-in;
i. AES-128 CBC-MAC Signature Key; and
j. AES-128 CBC-MAC Plug-in.

The authentication device 12 may be either a Feature Phone, or a Smartphone that generates a response to a prompt for identification, such as a prompt for a PIN. Authentication device 12 may comprise a dedicated software application used for transaction (hereinafter referred to as a ‘Transaction Data Prompt app’). The transaction data prompt app may preferably be in its ARM-TrustZone®—protected Trusted Execution Environment for added security.

The host server 16 is a transaction facilitator such as, but not limited to an e-Money Card Host capable of providing services as detailed in Philippines patent number 1-2004-000286 titled “Method and System for Macropayment and Micropayment Using Cellphone-Linked Virtual Card Accounts”. In particular, the services include the processing of transaction requests. The host server 16 is also capable of providing and generating virtual or electronic debit/credit card accounts and electronic wallets linked to respective fund sources so as to facilitate the completion of online transactions.

Host server 16 functions as an authentication host. Authentication host 16 is operable to receive encrypted/decrypted data sent from the authentication device 12, and further operable to decrypt/encrypt the data sent and process the transaction request to generate a prompt for identification to the source of the transaction request.

Host server 16 may be in data communication with an account Database 24. Account database 24 comprises the data associated with subscribers of the host server 16, and may include personal information such as account number and card number. Additionally, host server 16 is in data communication with a Hardware Security Module (HSM) 18 for purpose of authentication. HSM 18 is further operable to encrypt the prompt for identification and decrypt a response to the prompt for identification.

To communicate with the host server 16, data communication between the user device 12 and the host server 16 may be via a communication network 14. The communication network 14 is typically a gateway to the host server 16. The communication network 14 may include GSM SMS, GSM GPRS, 3G Data, Wi-Fi, or other TCP/IP-based networks.

The invention is next described in the context of usage where a customer 30 performs a web-based purchase transaction. It is to be appreciated that for illustration purpose, the authentication device 12 is described separately from the device/interface used for generating a transaction request via, for example, a browser 50.

As shown in FIG. 1, a Customer 30 who wishes to perform a web-based purchase transaction from an Online Merchant 40 assesses his browser 50 via a computer. The Customer 30 wishes to pay for the Purchase using an e-money card (which has a series of numbers similar to that of credit card/debit card's PAN). He is also holding the authentication device 12 that supports the ARM-TrustZone-protected TEE (Trusted Execution Environment) feature.

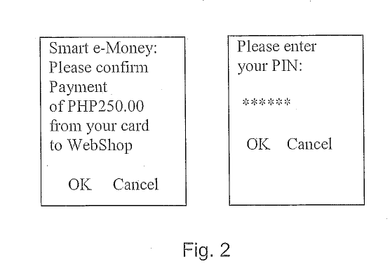

With reference to FIG. 1 and FIG. 2, the process flow for this example (also referred as ‘Push-based’ PIN or Password Prompt on Mobile Device 12) is as follows:
a) The Customer 30 places an order for goods/services on an Online Merchant website 40.
b) The Customer 30 enters his e-Money Card No. (sixteen (16) digit card number with necessary card security code (CSC) for payment.
c) The Online Merchant 40 routes the transaction (purchase) request to the e-Money Card Host 16.
d) The e-Money Card Host 16 uses the communication network (e.g. GSM GPRS) to send an encrypted ‘PIN Prompt Display’ request message to the authentication device 12. The PIN Prompt request is numbered (with a Transaction number), time-stamped, and signed using the SIM's AES-128 CBC-MAC Signature Key, as well as encrypted under the SIM's AES-128 Transaction Data Encryption Key.
e) The authentication device 12 receives a ‘PIN Prompt Display’ encrypted message, proceeds to decrypts it, validates the signature, and validates the Timestamp as within a reasonable time frame or margin of error of, say, 60 seconds (to prevent any Replay Attack).
f) The authentication device 12 may then play an audible beep and displays the PIN Prompt as shown in FIG. 2:
g) Upon being prompted, the Customer 30 enters his PIN and the crypto-SIM 20 is operable to perform the following:
   I. The SIM formats the PIN into standard ISO format.
   II. The SIM encrypts the PIN using the DUKPT Key.
   III. The SIM affixes the ‘PIN Prompt Display’ Transaction Number to the PIN Data, timestamps the transaction response, signs it using the SIM's signature key, and encrypts it using the SIM's encryption key.
h) The authentication device 12 further encrypts the entire transaction response under the standard GSM bearer key, then returns this response via the communication network 14, such as via GPRS to the e-Money Card Host.
i) Upon receiving the ‘PIN Prompt Display’ transaction response from the smartphone 12, the GPRS network 14 decrypts the response using the standard GSM bearer key.
j) Upon receiving the transaction response, the Card Host 16 performs the following:
   I. The Card Host 16 uses the HSM 18 to decrypt the transaction response using the SIM's decryption key.
   II. The Card Host 16 uses the HSM to validate the signature using the SIM's signature key.
   III. The Card Host 16 uses the HSM to decrypt and verify the PIN using the SIM's DUKPT key.
k) Having authenticated the cardholder/user, the Card Host 16 processes the payment accordingly and returns an ‘Approved’ response to the Online Merchant.
l) The Online Merchant 40, having received the ‘Approved’ response, displays on the webpage 50 that the transaction was approved and that the item is now ready for delivery.

It is to be appreciated that the authentication system 10 is be able to handle the case where the customer fails to enter his PIN within a reasonable amount of time of, say, 30 seconds. An example of handling would be to abort the transaction.

To process various requests and replies (non-replies) from the various parties, the host server 16 comprises three algorithms as follows. The algorithms depends on record locks, timers, and the keeping of a status field that tracks the ‘PIN Prompt Display’ transaction as either ‘Pending’, ‘Lapsed’, or ‘Completed’.

### Server Host 16 Three Process Algorithms

1. Upon receipt of a ‘purchase’ request, the host server 16 launches a ‘Main Transaction Handler’. The transaction request may be triggered by, a ‘Purchase’ request from an Online Merchant 40. The host server 16 is then operable to:
   (a) Retrieve the Account data (e.g. Account ID, Status, Mobile Phone Number).
   (b) If the Account data is missing or blocked, then decline the transaction.
   (c) Send the ‘PIN Prompt Display’ transaction request (with Transaction No.) to the Mobile Phone No. via the available access network (SMS, GPRS, 3G Data, Wi-Fi, etc).
   (d) Create a record of the ‘PIN Prompt Display’ transaction request, bearing the Request Date-Time and Status ‘Pending’.
   (e) Start the 30-second Timer that will launch the PIN Entry Period Entry Lapsed Timer Task.
   (f) End of Main Transaction Handler
2. Upon receipt of a PIN from authentication device 12, launch PIN Verifier Transaction Handler (triggered by receiving the ‘PIN Prompt Display’ transaction response from the authentication device 12)
The host server 16 is then operable to:
   (a) Receive the ‘PIN Prompt Display’ transaction response bearing the encrypted PIN and Transaction No.
   (b) Evoke the PIN Verifier Stored Procedure in the database 24, passing the Mobile Phone number (MSISDN) and Transaction number.
      i. Based on the Mobile Phone number and Transaction number, retrieve the ‘PIN Prompt Display’ transaction request record (which bears the Request Date-Time).
      ii. If the ‘PIN Prompt Display’ transaction request record does not exist (which should not normally happen), then respond with Response Code for “PIN Prompt transaction record does not exist”.
      iii. If the ‘PIN Prompt Display’ transaction record is ‘locked’ and cannot be retrieved, then return with Response Code for “PIN Prompt transaction record is locked by the PIN Entry Period Lapsed Timer Task”.
      iv. Otherwise lock the record.
      v. If Status is ‘Lapsed’, then release the lock (by updating the Request Date-Time with the current time), and return with Response Code for “PIN Entry Period has lapsed”.
      vi. Otherwise if Status is ‘Pending’, release the lock (by updating the Request Date-Time with the current time, and status with ‘Completed’), and return with Response Code for “Successfully retrieved the PIN Prompt transaction record”.
   (c) If the PIN Verifier Stored Procedure returned a Response Code for “Record does not exist”, then end this process.
   (d) If the PIN Verifier Stored Procedure returned a Response Code for “Currently locked by Timer Task”, then end this process.
   (e) If the PIN Verifier Stored Procedure returned a Response Code for “PIN Entry Period has lapsed” then end this process.
   (f) Otherwise (Status is ‘Pending’):
      i. Verify the PIN using the HSM.
      ii. Send the PIN-approved/declined Response Code to the caller of the PIN Verifier Transaction Handler.
   (g) End of PIN Verifier Task Handler
3. Upon non-receipt of a PIN from smartphone 12 within a predetermined period of time (‘reasonable period’), launch PIN Entry Period Lapsed Timer Task (started by the Main Transaction Handler and triggered by lapse of, say, 30 seconds)
   (a) Call the PIN Entry Lapsed Timer Task Stored Procedure, passing the Mobile Phone number. and Transaction number.
      i. Based on the Mobile Phone number and Transaction number, retrieve the PIN Prompt transaction record (bearing the Request Date-Time and Status).
      ii. If the PIN Prompt transaction record does not exist (which should not happen), then return with Response Code for “PIN Prompt transaction record does not exist”.
      iii. If the PIN Prompt transaction record is ‘locked’, then return with the Response Code for “PIN Prompt transaction record is currently locked by the PIN Verifier”.
      iv. Otherwise, lock the record.
      v. If Status is ‘Completed’, then release the lock and return with the Response Code for “PIN Entry already completed”.
      vi. Otherwise (Status is ‘Pending’), release the lock (by updating the status with ‘Lapsed’) and return with Response Code for “Successfully retrieved the PIN Prompt transaction record.
   (b) If the PIN Entry Lapsed Timer Task Stored Procedure returns Response Code for “Record does not exist”, then end this process.
   (c) If the PIN Entry Lapsed Timer Task Stored Procedure returns Response Code for “Currently locked by PIN Verifier”, then end this process.
   (d) If the PIN Entry Lapsed Timer Task Stored Procedure returns Response Code for “PIN Entry already completed”, then end this process.
   (e) Otherwise (Status is ‘Pending’):
      i. Send the Response Code for “PIN Entry Period has lapsed” to the caller of the Main Transaction Handler.
   (f) End of PIN Entry Period Lapsed Timer Task.
4. The invention is related to out-of-band account-holder authentication. The term ‘account’ may refer to a fund source—a card account, a bank account, an airtime load account, etc. The authentication is considered out-of-band because it is performed on a channel outside the main one being used for the transaction; e.g., a purchase transaction on the Internet being authenticated via GPRS.
5. The invention is intended to be an improvement to the existing SIM based authentication product as well as to its supporting backend. The invention will feature cryptographic functions for: (1) ANSI X9.24 DUKPT for PIN encryption, (2) AES-128 for transaction data encryption, and (3) Milenage for bearer encryption. These functions will be callable from a smartphone dedicated software application or ‘app’ via an API encrypted using GlobalPlatform-standard SCP (Secure Channel Protocol). For capable smartphones (equipped with an ARM Cortex A-8 and above central processing unit CPU), the PIN prompt and transaction data prompts will run in a GlobalPlatform-standard Trusted Execution Environment or TEE, which is a CPU-and-memory area that is hardware-protected from snooping of code and data by viruses and spyware running on unprotected memory along with other mobile apps. Less capable smartphones will have to run the PIN prompt and transaction data prompts in unprotected memory areas but will still have the benefit of calling the cryptographic functions in the SIM via Secure Channel Protocol, which will lessen the security risk to some extent. Compatibility with feature phones will be provided via STK-based PIN prompt and transaction data prompts calling the same cryptographic functions mentioned above.

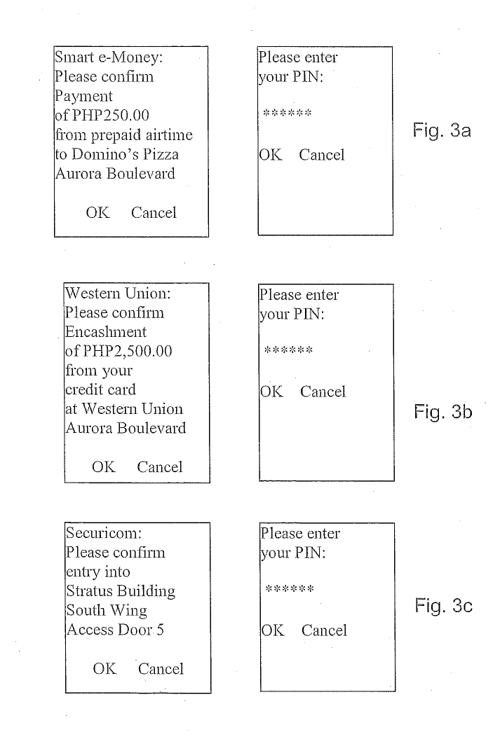

It should be appreciated by the person skilled in the art that variations and combinations of features described above, not being alternatives or substitutes, may be combined to form yet further embodiments falling within the intended scope of the invention. In particular:
The authentication device 12 can be a feature phone or smartphone. The crypto-SIM 20 should be able to accommodate both types of handsets.
The authentication device 12 may be integrated with the device (and browser) 50 used for performing the transactions.
As to the other components of the invention, the Accounts Host 16 can be an e-money card host or any host managing accounts for a particular application (even, say, door lock access). The HSM will be the same regardless of application.
The PIN Prompt should work with any bearer, whether SMS, GSM GPRS, 3G Data, 802.11b/g/n Wi-Fi, or any TCP/IP network.
The authentication device 12 is also not restricted to mobile phone, but could also be a tablet, or a USB device attached to the laptop.
The authentication token entered by the user is not restricted to PIN, but could also be a Password.
The identification (PIN) Prompt process will vary depending on the service provider and the application. For illustration, FIG. 3a shows an example of a PIN prompt for a pizza delivery purchase paid from prepaid air-time; FIG. 3b shows an example of a PIN prompt for a money transfer service (using Western Union for example); and FIG. 3c shows an example of a PIN Prompt for a door lock access service.

For the case where the authentication device 12 is integrated with the device (and browser) 50 used for performing the transactions, it is to be appreciated that the security of the transaction is further enhanced. In this case, the Purchase transaction request itself could be encrypted under the SIM's Transaction Data Encryption Key, instead of just under SSL on a laptop. The SIM is then used not just for 2-factor authentication but also for transaction data encryption.

Aside from on-site Point-of-Sale authentication, the other application that could be appreciated is off-site authentication; i.e., authentication of the cardholder far from the Point-of-Sale, or “Remote Purchase” as illustrated in the description.

1. An authentication system comprising
an authentication device comprising a subscriber identity module (SIM) operable to encrypt data; the authentication device capable of sending the encrypted data and receiving encrypted data over a communication network; and
an authentication host operable to encrypt an authentication request and send the encrypted authentication request over the communication network to the authentication device;
wherein the authentication request, which comprises at least a time stamp, is signed by a first digital signature; and wherein the authentication device is operable to validate the first digital signature and timestamp before generating an encrypted authentication response in response to the encrypted authentication request, the encrypted authentication response which comprises at least a personal identification number (PIN) is signed by a second digital signature.

2. The authentication system according to claim 1, wherein the authentication host comprises a hardware security module (HSM) operable to encrypt or decrypt the encrypted data.

3. The authentication system according to claim 2, wherein the HSM is operable to validate the second digital signature.

4. The authentication system according to claim 2, wherein the HSM is operable to validate the PIN.

5. The authentication system according to claim 1, wherein the authentication host is operable to receive a transaction request from a merchant.

6. The authentication system according to claim 5, wherein upon receipt of the transaction request, the authentication host is operable to encrypt the transaction request and sends the authentication request to the authentication device.

7. The authentication system according to claim 1, wherein the authentication host comprises an account database for verifying the transaction request.

8. An authentication device comprising a subscriber identity module (SIM), the SIM operable to encrypt and decrypt data in relation to an authentication request sent over a communication network, the SIM comprising at least two encryption protocols; wherein the authentication request, which comprises a time-stamp, is signed by a first digital signature; and wherein the SIM is operable to encrypt an authentication response in response to the authentication request, wherein the encrypted authentication response which comprises a personal identification number (PIN) is signed by a second digital signature.

9. The authentication device according to claim 8, wherein the at least two encryption protocols comprises at least two of the following:—Standard GSM or 3G Authentication Keys; GSM 03.48 Bearer Encryption Key; STK-based PIN Prompt; STK-based Transaction Data Prompt; ANSI X9.24 DUKPT 128-bit PIN Encryption Key; ANSI X9.24 DUKPT Plug-in; AES-128 Transaction Data Encryption Key; AES-128 Plug-in; AES-128 CBC-MAC Signature Key; and AES-128 CBC-MAC Plug-in.

10. The authentication device according to claim 8, wherein upon receipt of an authentication request that includes a personal identification number from a user, the authentication device formats the personal identification number into a standard ISO format and encrypts the PIN using a DUKPT encryption key.

11. The authentication device according to claim 10, wherein the SIM is further operable to generate a transaction number to the PIN, and append the transaction number and PIN.

12. The authentication device according to claim 11, wherein the SIM is operable to timestamp the response to the request for authentication and generate a SIM signature key.

13. An authentication host operable to receive a transaction request, and encrypt the transaction request to generate a prompt for authentication; the authentication host comprises a hardware security module (HSM) for encrypting the prompt for authentication and decrypting a response to the prompt for authentication;
wherein the prompt for authentication comprises a data packet comprising a transaction number, time stamp, and a digital signature and
wherein the response to the prompt for authentication is generated after validating the prompt for authentication at least by way of the time stamp and digital signature.

14. An authentication method comprising the steps of:
a. encrypting an authentication request and sending the authentication request from an authentication host to an authentication device, wherein the encrypted authentication request, which comprises of at least a time stamp, is signed by a first digital signature;
b. decrypting the authentication request and validating the time stamp and the first digital signature;
c. prompting a user for a personal identification number (PIN) entry by the authentication device; and
d. encrypting an authentication response and sending the authentication response to the authentication host, wherein the encrypted authentication response which comprises of the PIN is signed by a second digital signature.
